(19) United States
(12) Patent Application Publication
(10) Pub. No.: US 2014/0071475 A1
(43) Pub. Date: Mar. 13, 2014

(54) DOCUMENT MANAGEMENT SYSTEM AND FUNCTION LIMITING SERVER

(71) Applicants: TOSHIBA TEC KABUSHIKI KAISHA, Tokyo (JP); KABUSHIKI KAISHA TOSHIBA, Tokyo (JP)

(72) Inventor: Shunichi MEGAWA, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/960,649

(22) Filed: Aug. 6, 2013

(30) Foreign Application Priority Data
Sep. 7, 2012 (JP) 2012-197786

(51) Int. Cl. G06F 3/12

(52) U.S. Cl. CPC G06F 3/1239
USPC 358/1.14

(57) ABSTRACT

A document management system includes an image forming apparatus, an acquisition section, a document information management server, and a function limiting server. The acquisition section receives identification information of a document to be printed. The document information management server maintains an attribute information table that has identification information and attribute information of different documents stored therein, and retrieves attribute information of the document corresponding to the identification information received by the acquisition section. The function limiting server limits print functions of the image forming apparatus when printing the document having the identification information received by the acquisition section according to a printing policy that is based on the attribute information of the document retrieved by the document information management server.

### CROSS-REFERENCE TO RELATED APPLICATION

This application is based upon and claims the benefit of priority from Japanese Patent Application No. 2012-197786, filed Sep. 7, 2012, the entire contents of which are incorporated herein by reference.

### FIELD

Embodiments described herein relate to a technology for limiting a printing function of an image forming apparatus.

### BACKGROUND

In the related art, technology for limiting the printing function of an image forming apparatus has been developed to decrease operating costs and the load on the environment. The limitation of the printing function includes, e.g., the limitation of the print number or the limitation of the color (multicolor, monochrome) for each user, limitation of the printed side(s) (double-sided, single-sided), N-in-1 printing, and the like.

However, in the related art, the limitation of the printing function is carried out on the basis of user rights, which is insufficient in limiting the printing function for a variety of purposes and applications. This is undesirable.

### DESCRIPTION OF THE DRAWINGS

FIG. 1 is a diagram illustrating a document management system according to a first embodiment.

FIG. 2 is a flow chart illustrating a document management process carried out by the document management system.

FIG. 3 is a diagram illustrating a printing request input screen.

FIG. 4 is a diagram illustrating a distribution destination input screen.

FIG. 5 is a diagram illustrating an attribute information table before refresh.

FIG. 6 is a diagram illustrating an attribute information table after refresh.

FIG. 7 is a diagram illustrating a user information table.

FIG. 8 is a diagram illustrating a printer information table.

FIG. 9 is a diagram illustrating a printing policy table.

FIG. 10 is a diagram illustrating a printer driver screen.

FIG. 11 is a diagram illustrating another printer driver screen.

FIG. 12 is a diagram illustrating an attribute information table after refresh in a second embodiment.

FIG. 13 is a diagram illustrating a printing policy table.

FIG. 14 is a diagram illustrating a print setting screen of a client PC.

FIG. 15 is a diagram illustrating an attribute information table after refresh.

FIG. 16 is a diagram illustrating a user information table.

FIG. 17 is a diagram illustrating a printing policy table.

FIG. 18 is a diagram illustrating a printing policy table in a third embodiment.

FIG. 19 is a diagram illustrating an output destination display screen.

FIG. 20 is a diagram illustrating a printing standby input screen in a fourth embodiment.

FIG. 21 is a diagram illustrating another printing standby input screen.

FIG. 22 is a flow chart illustrating the document management process in a fifth embodiment.

### DETAILED DESCRIPTION

Embodiments provide a technology that can limit the printing function of an image forming apparatus for a variety of purposes and applications. In general, the embodiments will be explained with reference to the drawings.

According to an embodiment, the document management system comprises an image forming apparatus, an acquisition section, a document information management server, and a function limiting server. The image forming apparatus forms an image on a sheet. The acquisition section receives an identification information of the document required to be printed. The document information management server has an attribute information table that stores the identification information of documents with attribute information of the documents, and it sends the attribute information of the document corresponding to the identification information of the document received by the acquisition section. The function limiting server has a printing policy table that stores information based on the attribute information of the document that limits the printing function of the image forming apparatus, and causes the printing function to be limited.

### First Embodiment

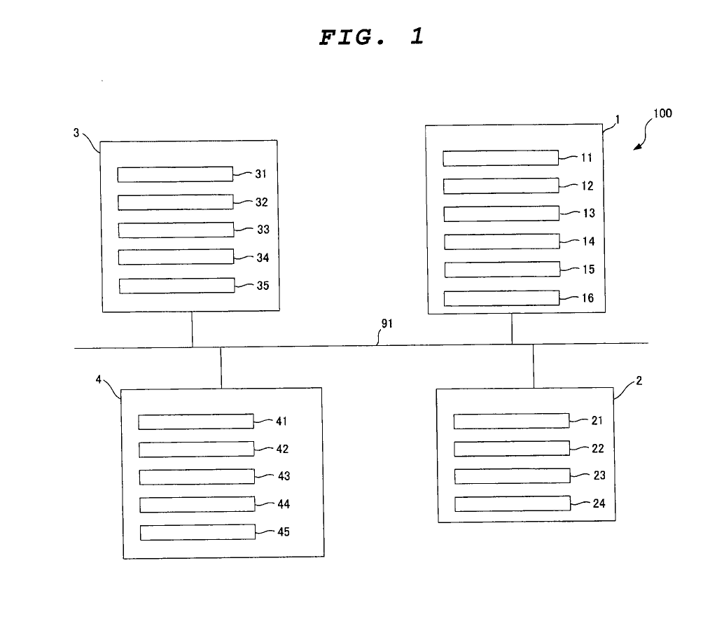

FIG. 1 is a diagram illustrating a document management system 100.

The document management system 100 comprises an image forming apparatus 1, such as an MFP (multi-function peripheral), a client PC 2 (personal computer), a document information management server 3, a printer management server 4 (function limiting server), and a network 91 (electrical communication line) that connects them.

The elements 1 through 4 have display sections 11, 21, 31, 41, such as touch panels, and liquid crystal panels, and operation input sections 12, 22, 32, 42, such as touch panels, mouses, keyboards and buttons, for the user to carry out an input operation. The elements 1 through 4 also have control sections 13, 23, 33, 43 each containing a CPU (Central Processing Unit) that carries out various types of arithmetic and logic operation processing, a memory and a HDD (Hard Disk Drive) that store various types of programs and variables to be read to the CPU, and an ASIC (Application Specific Integrated Circuit) for realizing the prescribed function.

Although only one image forming apparatus 1 is shown in FIG. 1, it should be understood that one or more image forming apparatus 1 may be connected to the network 91. Each image forming apparatus 1 has a display section 11, an operation input section 12, a control section 13, as well as a read section 14 that reads the document and creates a PDF (Portable Document Format) or other image data, an image forming section 15 that forms an image on the sheet on the basis of the image data, and a user authentication section 16. Here, on the basis of the input information, the user authentication section 16 authenticates the user, and gives the user permission to login. The information for authentication may be user ID and password that are received as an input, information obtained by reading an ID card, or the finger print or other bio information received as an input. The sheet on which the image is formed by the image forming apparatus 1 is not limited to printing paper. It may also be an OHP (Over Head Projection) sheet, etc.

First of all, a brief description will be provided for the document management system 100.

In the document management system 100 of the present embodiment, an attribute information table 34 that has the deadline, version, and other attribute information attached corresponding to the identification number of each document is preset by the administrator of the document management system 100 in the document information management server 3. In addition, in the printer management server 4, the administrator presets in advance a printing policy table that has the attribute information of document (for example, the deadline) and the limitation of the printing function (such as limiting the printing of documents to monochromic, double-sided, and 2-in-1 printing mode within the deadline of 1 month) correspond to each other.

When the client PC 2 receives a request to print a document file in the client PC 2 that has its identification number and attribute information managed by attribute information table 34, the client PC 2 sends the identification number of the document file and the document file via the printer management server 4 to the document information management server 3.

As a result, the document information management server 3 sends the attribute information (for example, the deadline) of the document file corresponding to the received identification number of the document file via the printer management server 4 to the client PC 2. Consequently, under control of the client PC 2, printing is carried out with limited printing function, such as monochromic, double-sided, and 2-in-1 printing mode, corresponding to the received attribute information (for example, the deadline).

In addition, in the document management system 100, for example, the printer management server 4 describes the limitation of the printing function, such as monochromic, double-sided, and 2-in-1 printing mode, in the document file received from the client PC 2, and sends it to the image forming apparatus 1. Then, the image forming apparatus 1 prints the document file with the printing function having been limited by the printer management server 4.

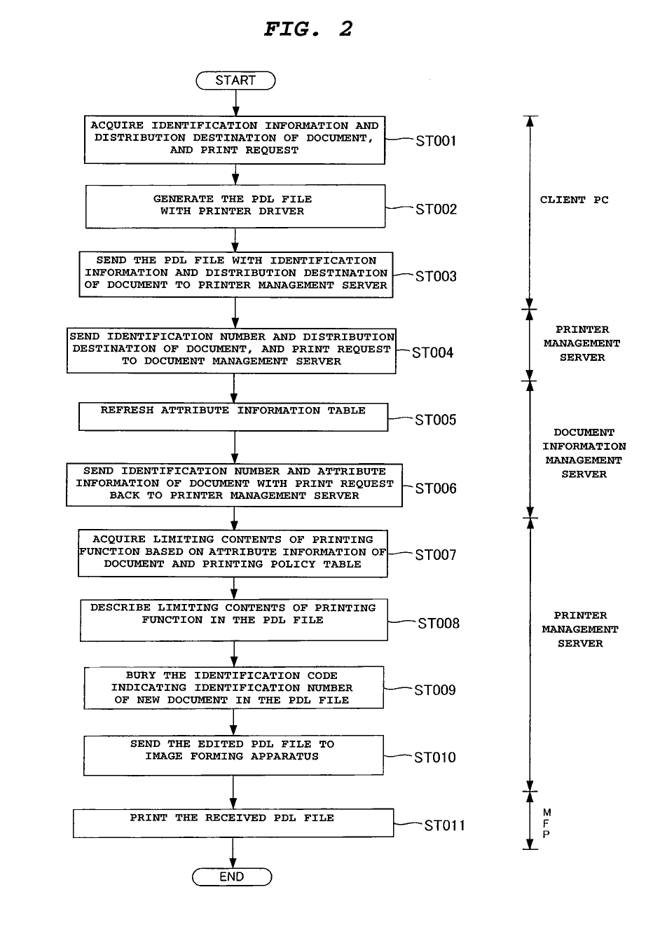

With reference to FIGS. 1 and 2, the document management processing and the functions 2 through 4 of the various elements of the document management system 100 will be explained below.

The client PC 2 comprises a display section 21, an operation input section 22, a control section 23 as well as a mark read section 24. The mark read section 24 reads the QR Code® indicating the identification number (identification information) of the document as an identification code or other identification code formed on the document.

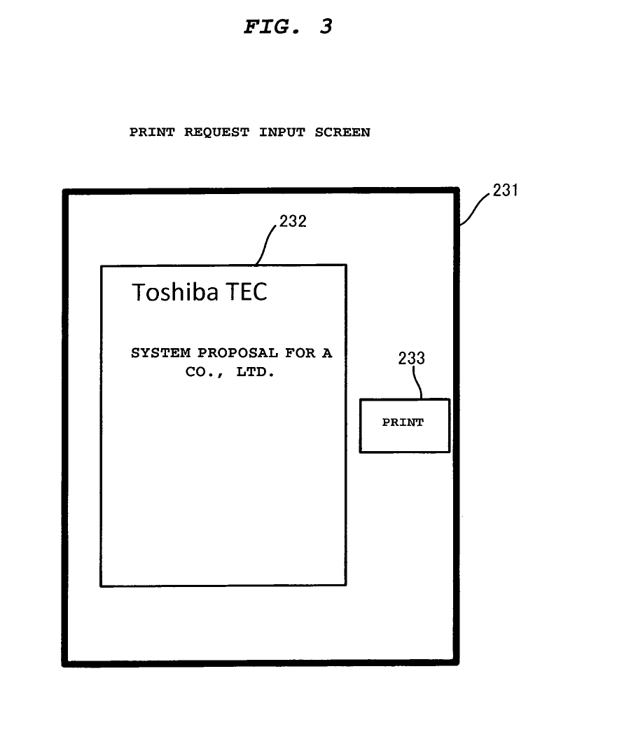

The control section 23 receives the selection of the document file to be printed and the distribution destination of the document, and sends a message about the identification number and distribution destination of the document file as well as the request for printing the document file to the printer management server (ST001 through ST003). More specifically, the control section 23 receives the selection of the document file to be printed and displays a printing request input screen 231 on the display section 21 by an application as shown in FIG. 3. The control section 23 displays the selected document file on a document display section 232, and receives the input of operation on the printing button 233.

Here, the client PC 2 retains the PDF (Portable Document Format) or other document file downloaded from the document information management server 3, and attaches the identification number as a property on the document file. When the operation of a printing button 233 is received on the printing request input screen 231, the control section 23 acquires the request for printing of the document file, and, at the same time, it acquires the identification number attached on the document file. According to the present embodiment, the identification number is assumed to be D1000.

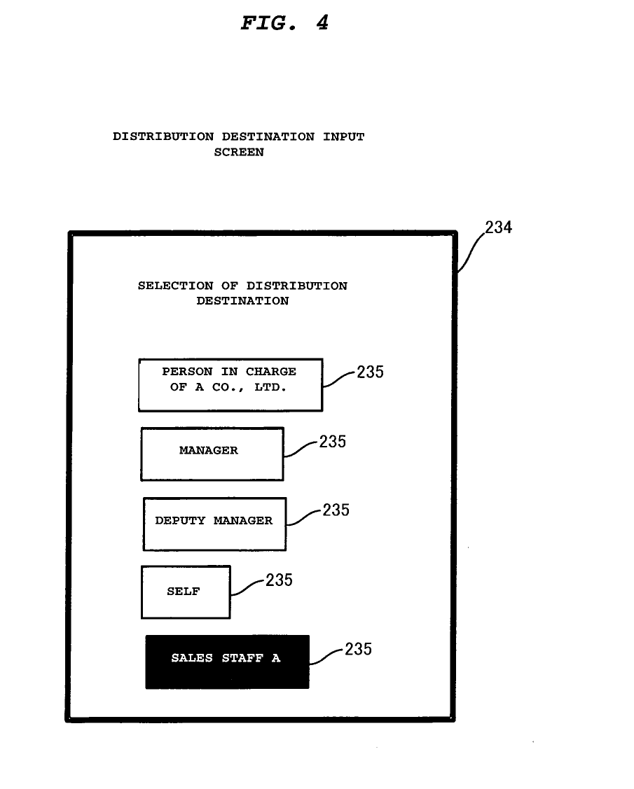

Then, the control section 23 displays the distribution destination input screen 234 shown in FIG. 4 by an application, and receives the distribution destination of the document file. According to the present embodiment, the control section 23 displays plural selecting buttons 235 indicating the distribution destination, and receives sales staff A as the distribution destination of the document file (ST001).

The control section 23 generates the PDL (Page Description Language) file with the printer driver on the basis of the document file (ST002).

The control section 23 sends the identification number and distribution destination of the document file and the PDL file to the printer management server (ST003).

The steps ST001 through ST003 of the control section 23 may also be adopted in the case where the document of the document file downloaded and printed from the document information management server 3 is copied. In this case, an identification code indicating the identification number of the document file is attached to the document. The control section 23 uses the mark read section 24 to read the identification code to acquire the identification number of the document file (D1000 in this embodiment). In addition, as the document is read by the image forming apparatus 1, the control section 23 acquires the PDF file or other document file. Then, by means of the printing request input screen 231 and a distribution destination input screen 234, the control section 23 receives the request for printing and the distribution destination of the document file, and sends the identification number and distribution destination of the document file and the PDL file (the printing request of the document file) to the printer management server 4 (ST001 through ST003).

The printer management server 4 sends the identification number and distribution destination of the document file as well as the printing request of the document file and the request for printing the document file to the document information management server 3 (ST004).

The document information management server 3 comprises a display section 31, an operation input section 32, and a control section 33 (acquiring section), as well as an attribute information table 34 and a user information table 35 stored in memory or a storage section of the HDD or the like.

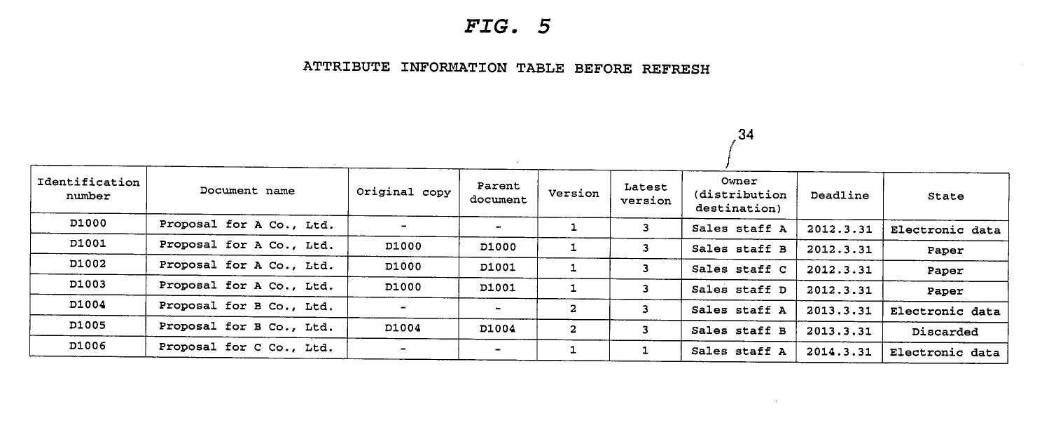

FIG. 5 is a diagram illustrating the attribute information table 34 before refresh. FIG. 6 is a diagram illustrating the attribute information table 34 after refresh.

The control section 33 of the document information management server 3 refreshes the attribute information table 34 on the basis of the received identification number and distribution destination of the document file as well as the printing request of the document file (ST005).

In the attribute information table 34 shown in FIG. 5, the identification number of the document and the attribute information (referred to hereafter as “the first attribute information”) of the document are stored and associated with each other. The identification number is a number for uniquely identifying the document. The attribute information of the document specifies the document name, original copy, parent document, version, latest version, owner, deadline, and its state.

The “document name” field in the document attribute information shows the title of the document file or the original. The “original copy” field indicates whether the document file or the original is the most original copy. The “parent document” field shows the identification number of the document file of the direct copy source of the document file or the original. The “state” field shows whether the document is electronic data, an original of a paper media, or discarded.

The entry for the document with identification number D1000 shows that it is an original document (because its “original copy” field is empty) of the proposal for A Co., Ltd., and its “state” field indicates that the document is electronic data. The entry for the document with identification number D1001 shows that the document with identification number D1000 is both the original copy and the parent document thereof. In addition, the state indicates the document with identification number D1001 is on paper. The documents with identification numbers D1002 and D1003 are documents that have the document with the identification number D1001 as their parent document, and are copies of the document with identification number D1001.

From the “version” field and the “latest version” field in the document attribute information, it is possible to find out whether a particular document is the latest document by comparing the values of the two fields. The “owner (distribution destination)” field indicates the party who owns the document and the distribution destination of the document. The “deadline” field refers to the scheduled discard date for the document.

The control section 33 of the document information management server 3 works as follows: when an identification number and distribution destination of the document file as well as the printing request of the document file are received, an entry for the identification number is added to the attribute information table 34, that is, in this embodiment, an entry for D1007 is added (FIG. 6). Also, the control section 33, in the entry for D1007, fills in D1000 in the columns of “original copy” and “parent document” to indicate that the document D1000 is the original copy and the parent document of document D1007. At the same time, the prescribed attribute information (version, latest version, deadline) of the original document D1000 is filled in. In addition, the column of the “owner” has the received distribution destination of “sales staff A” filled in, and the column of “state” has “paper” filled in indicating the document is a paper document after printing (ST005).

After refresh of the attribute information table 34, the control section 33 of the document information management server 3 sends to the printer management server 4 the document attribute (document name, version, new version, owner, deadline, state, etc.) corresponding to the identification number D1000 of the received document file as stored in the attribute information table 34 (ST006).

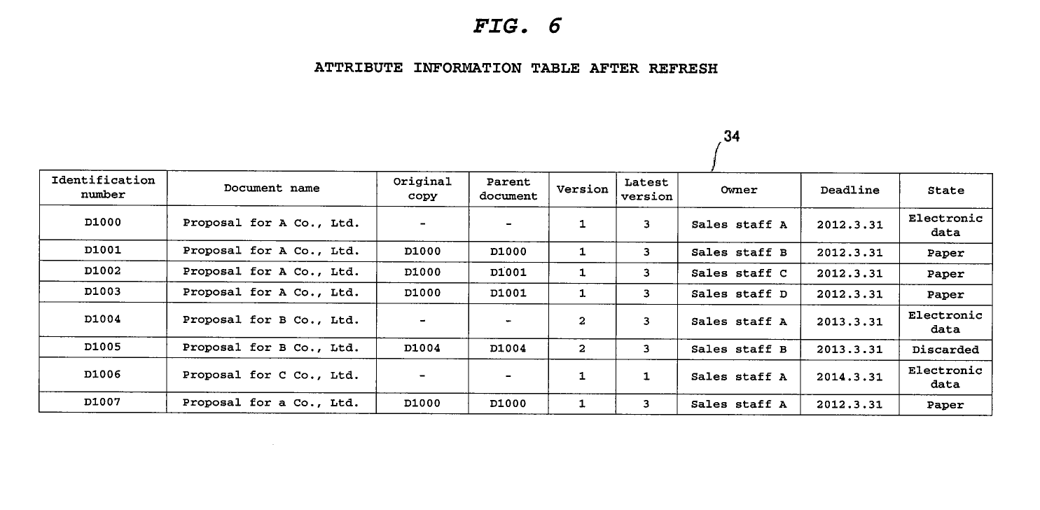

FIG. 7 is a diagram illustrating the user information table 35.

In addition to the attribute information table 34, the document information management server 3 also maintains the user information table 35. In the user information table 35, the user name, affiliate, position, and owned documents are arranged corresponding to the identification number of each user. The user information table 35 is preset in the document information management server 3 by the administrator of the document management system 100. The preset portion includes the identification number, name, affiliate, and position of each user.

The column of “document owned” is a portion filled with the identification number of each user when the control section 33 refreshes the user information table 35 in ST005. As shown in FIG. 6, sales staff A with identification number U1002 is an ordinary staff of the Sales Division, and owns the three documents with identification numbers D1000, D1004 and D1006.

The printer management server 4 comprises a display section 41, an operation input section 42, a control section 43, as well as a printer information table 44 and a printing policy table 45 accommodated in a memory or the storage section of the HDD or the like.

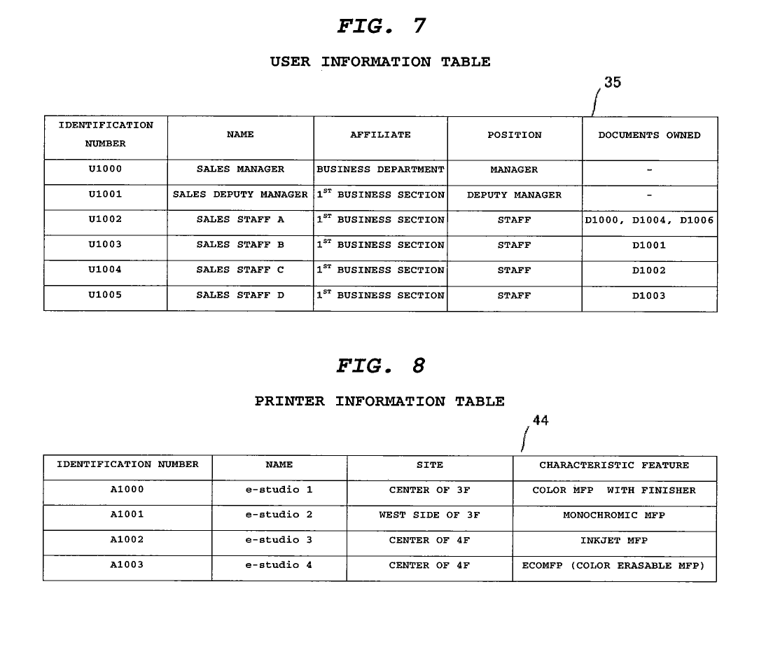

FIG. 8 is a diagram illustrating a printer information table 44.

The printer information table 44 stores printer information, e.g., information of one or more of the image forming apparatus 1, such as a printer or a multi-function peripheral or the like, that are connected to the printer management server 4 and the network 91. As shown in FIG. 8, the name, site and characteristic features are stored correspondingly to the identification number of each image forming apparatus. The name shows the printer name. The site shows the floor or area name, or the like. The characteristic features show the characteristic features of the printer, such as color/monochromic, the presence of finisher, electrophotographic/inkjet/Eco-MFP (multi-function peripheral that allows printing with a color erasable toner or ink). The printer information table 44 is set by the administrator of the document management system 100 in the printer management server 4.

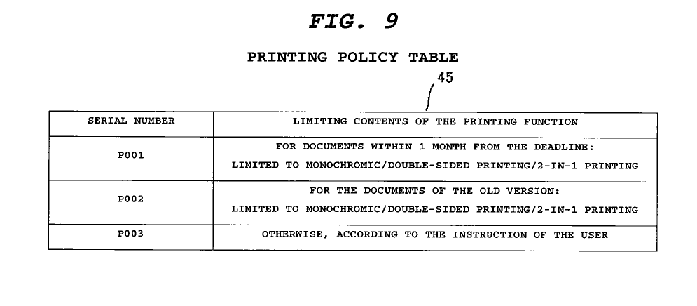

FIG. 9 is a diagram illustrating a printing policy table 45.

The printing policy table 45 is preset by the administrator of the document management system 100 in the printer management server 4. The printing policy table 45 defines the limiting contents of the printing function and a serial number is set for each limiting content of the printing function.

For example, a document near the end of the deadline is likely to be printed for temporary use and will soon be discarded. Consequently, in order to suppress the printing cost and the load on the environment, serial number P0001 limits documents that are within one month of its deadline to the printing function of monochromic/double-sided printing/N-in-1 printing. In addition, serial number P002 limits documents that are old version to the printing function of the monochromic/double-sided printing/N-in-1 printing.

With reference to the printing policy table 45, the control section 33 acquires the limiting contents of the printing function corresponding to the attribute information of the document received from the document information management server 3 (ST007). For example, if a document received from the document information management server 3 has a deadline of Mar. 31, 2012, the control section 33 computes the period from the current time to the deadline of Mar. 31, 2012. If the computed period meets the time condition set forth in the printing policy table 45, the control section 33 acquires the “contents of limiting of the printing function” corresponding to that condition, e.g., monochromic/double-sided printing/N-in-1 printing, as the limiting contents of the printing function.

In addition, if the version of the document received from the document information management server 3 is “1” and the latest version is “3”, the control section 33 determines that the document is not the latest version, i.e., it is an old version. Therefore, the control section 33 acquires the “limiting contents of the printing function” for old versions, e.g., monochromic/double-sided printing/N-in-1 printing, as the limiting contents of the printing function.

According to the present embodiment, the same limiting contents of the printing function is defined for documents that are being printed within one month of its discard deadline and “old” version documents. In other embodiments, different limiting contents of the printing function may be defined.

The control section 33 attaches the limiting contents of the printing function to the PDL file of the document acquired by the printer management server 4 from the client PC 2 (ST008). For example, when the PDL file of the document is PS (Post Script), the control section 33 describes the instruction of “monochromic/double-sided printing/N-in-1 printing” in the image forming apparatus 1 in the file head portion of the PJL (Printer Job Language).

The control section 33 also attaches the identification code indicating the document identification number D1007 to the PDL file of the document having the limiting contents of the printing function described therein (ST009). According to the present embodiment, because the client PC 2 makes the printing request of the document, the identification code is attached to the PDL file of the document. However, when the client PC 2 makes a request for transmission of the document file (with another client PC or the like), the identification code is added as metadata to the PDF or other document file.

The control section 33 sends the edited PDL file to the image forming apparatus 1 (ST010).

The image forming apparatus 1 then prints the document according to the limitation of the printing function described in the PDL file (such as monochromic/double-sided printing/N-in-1 printing) (ST011).

In the example described above, the explanation has been made under the precondition that all of the processing end normally. However, for the image forming apparatus 1, failure of printing due to paper jam or the like may occur. In consideration of this problem, in ST005, if an abnormality occurs in a certain process or a stop instruction is received from the user after issuing of the attribute information of the new document D1007, the document information management server refreshes the attribute information table 34, and the identification number of the new document D1007 as well as the attribute information corresponding to the document D1007 are deleted from the attribute information table 34. Then, the document information management server 3 refreshes the user information table 35, and deletes the document D1007 corresponding to, and owned by, a certain user.

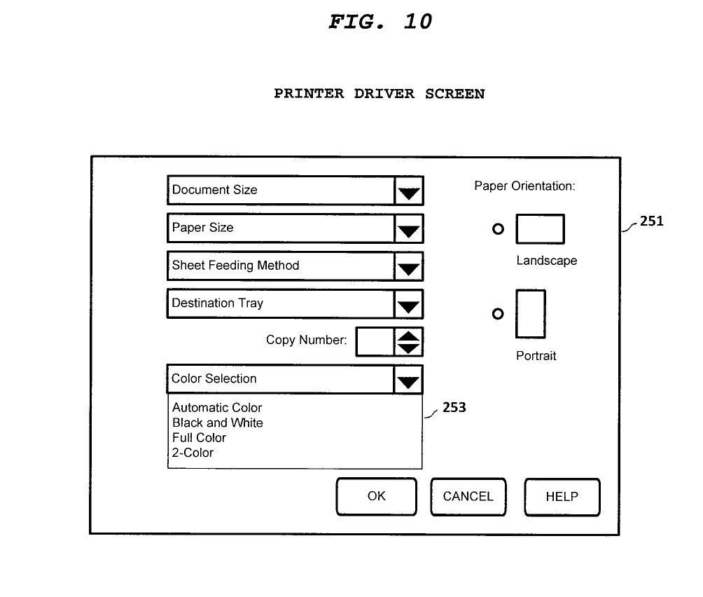

FIGS. 10 and 11 are diagrams illustrating printer driver screens 251 and 252 displayed on the basis of the limiting instruction of the printing function.

In the aforementioned embodiment, the printer management server 4 has the limiting instruction of the printing function attached to the PDL file. However, the printing limiting instruction determined by the printer management server 4 may not necessarily be in agreement with the demand of the user. Here, the following scheme may be adopted: instead of making the limiting instruction of the printing function that cannot be amended by the user, the printer management server 4 makes a limiting instruction of the printing function that can be amended by the user, that is, that allows for the cancellation of the function limiting. More specifically, the printer management server 4 may send the limiting instruction of the printing function of “monochromic/double-sided printing/N-in-1 printing” to the client PC 2. Then, the client PC 2 displays the printer driver screen 251 or 252 as the printing setting screen on the basis of the limiting instruction of the printing function.

In the client PC 2, the color selecting section 253 on the printer driver screen 251 shown in FIG. 10 is in a state where it has the “black and white” selected. If the user desires color printing, the user is allowed to change the “black and white” selection. By means of the client PC 2, both the double-sided printing selecting portion 254 and the N-in-1 selecting portion 255 on the printer driver screen 252 of FIG. 11 have the checkboxes checked, so that the state has the double-sided printing and the N-in-1 printing selected. However, if the user desires single-sided printing and 1-in-1 printing, the user can simply remove checking of the checkboxes so as to select the single-sided printing and 1-in-1 printing.

According to the present embodiment, with the configuration described above, it is possible to control the printing function not only by the user as his/her rights, but also on the basis of the various attribute information of the document as the printing object. Consequently, it is possible to limit the printing function for the various purposes and applications, and it is possible to suppress the printing cost and the load on the environment.

### Second Embodiment

In the embodiment described above, in the document management system 100, while the identification information of the document and the attribute information of the document (the first attribute information) are set corresponding to each other beforehand, the attribute information of the document and the limiting contents of the printing function are also set corresponding to each other. As a result, according to the embodiment described above, the document management system 100 performs the limiting instruction of the printing function corresponding to the identification information of the document.

In the document management system 100 according to a second embodiment, the limiting instruction of the printing function is made corresponding to the document attribute information (the second attribute information, such as the distribution destination) input by the user to the document management system 100. Here, the document attribute information preset corresponding to the document identification information is taken as the first attribute information, while the document attribute information input to the document management system 100 is taken as the second attribute information.

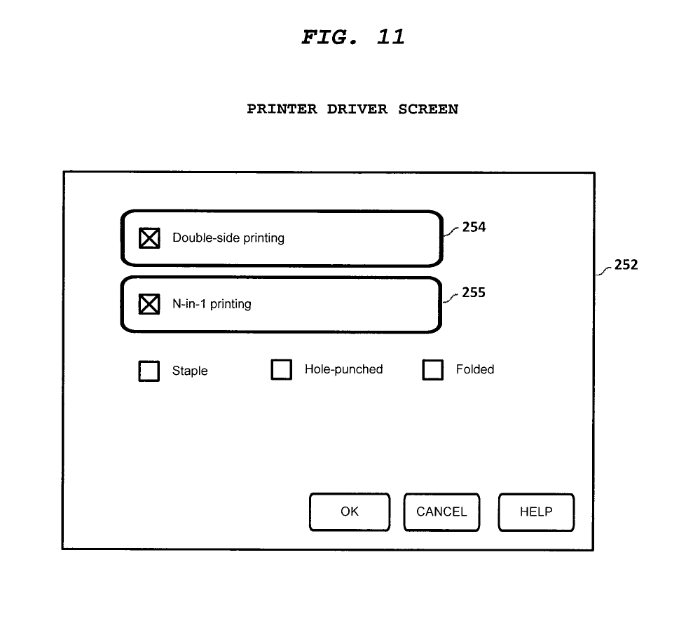

In the following, explanation will be made mainly for the features of the document management process in the second embodiment different from that of the first embodiment, while only a brief account will be given on the features the same as those in the embodiment described above. FIG. 12 is a diagram illustrating the attribute information table 34A of the document information management server 3 after refresh.

In the second embodiment, as the sales staff A enters the operation, the client PC 2 receives the request for printing the document file, and, at the same time, receives a message that distribution destinations (the second attribute information) include the director of the sales department and the sales staff B, and it sends the PDL file of the document, the identification number D1000 of the document, and the distribution destinations of “director of the sales department” and “sales staff B” for the document to the document information management server 3.

The document information management server 3 sends the identification number D1000 of the document and the distribution destinations “director of the sales department” and “sales staff B” of the document to the printer management server 4.

The printer management server 4 then refreshes the attribute information table 34A, adds new identification numbers D1001, D1002 to the distribution destinations, respectively, and, at the same time, it has the attribute information (document name, original copy, parent document, etc.), the distribution destination of “director of the sales department” or “sales staff B” and the state of the “paper” of the original document D1000 set corresponding to the identical numbers D1001, D1002.

Then, the printer management server 4 sends the new identification numbers D1001, D1002 and the various attribute information to the document information management server 3.

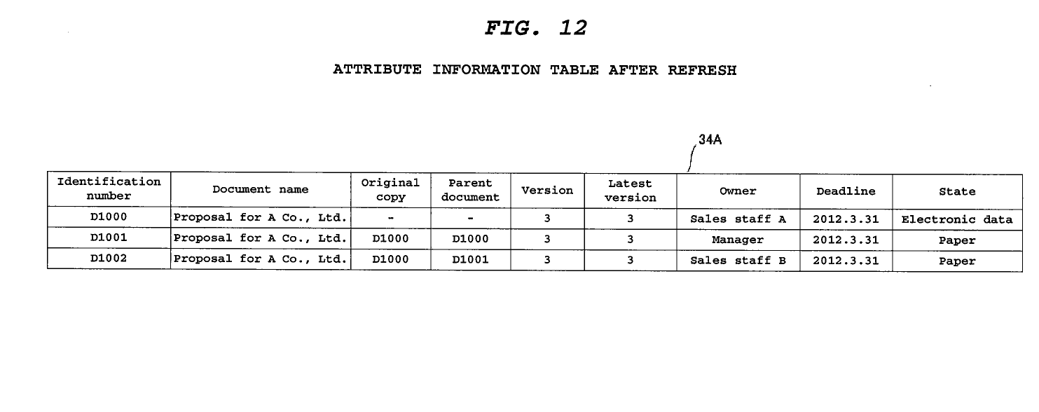

FIG. 13 is a diagram illustrating a printing policy table 45A.

The printing policy table 45A of the document information management server 3 defines the limiting contents of the printing function according to the distribution destination.

For example, with the serial number of P001, the color printing mode is set corresponding to the distribution destination of A Co., Ltd.; with the serial number of P002, the color printing mode is set corresponding to the sales managers of departments or higher officers in the company as the distribution destination; with the serial number of P003, the monochromic printing mode is set corresponding to the sales deputy managers in the company as the distribution destination; and, with the serial number of P004, the monochromic/double-sided printing/N-in-1 printing mode is set corresponding to the staffer in the company as the distribution destination.

The document information management server 3 has the description instructing the color printing attached to the PDL file of the document D1001 that has the manager of business as the distribution destination, and, at the same time, it has the identification code indicating the identification number D1001 embedded in the PDL file sent to the image forming apparatus 1. Also, the document information management server 3 has the description instructing the monochromic/double-sided/2-in-1 printing mode attached to the PDL file of the document D1002 that has the sales staff B as the distribution destination, and, at the same time, it has the identification code indicating the identification number D1002 embedded in the PDL file sent to the image forming apparatus 1.

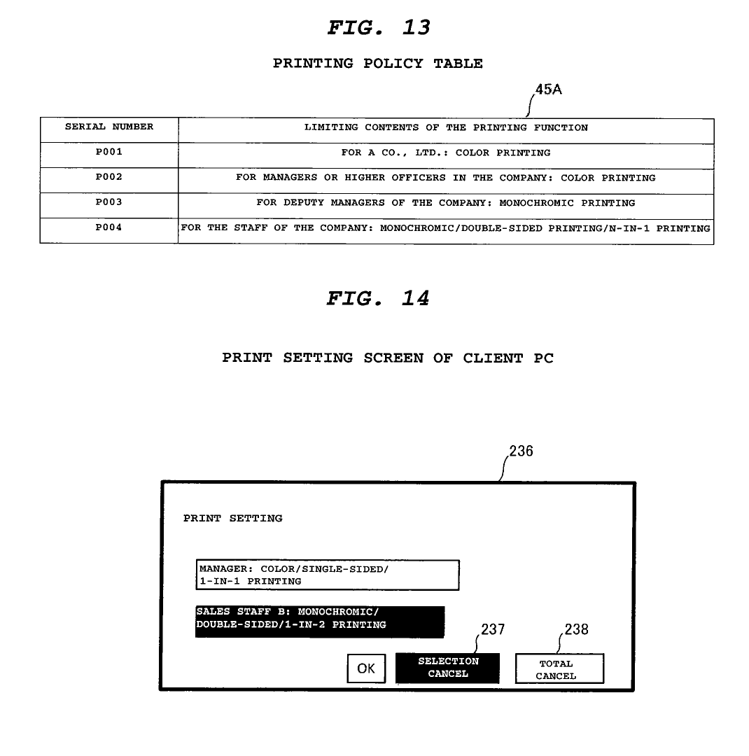

FIG. 14 is a diagram illustrating a print setting screen 236 of the client PC 2.

In the above explanation of the second embodiment, the limiting instruction of the printing function is written in the PDL file by the printer management server 4. However, as pointed out in the explanation for the first embodiment, the printer management server 4 may also send the limiting instruction of the printing function to the client PC 2. Here, the client PC 2 may also display the print setting screen 236 based on the instruction of the limiting of printing, and the displayed print setting screen 236 shows to whom the document is to be sent and what is the setting for printing the document. On the print setting screen 236, it is also possible to set a selection cancel button 237 and a total cancel button 238 for accepting the request for printing. As the client PC 2 receives the operation input with these buttons 237, 238, it sends the stop request via the printer management server 4 to the document information management server 3. Then, the document information management server 3 has the information related to the stopped distribution destination (i.e., the attribute information and the identification number of the document to be sent to the distribution destination) deleted. In addition, when the selection cancel button 237 is pressed for input, the client PC 2 requests deletion of only the information related to the selected distribution destination. When the total cancel button 238 is pressed for input, it requests deletion of the information related to all of the distribution destinations that made the printing request.

In the example described above, the attribute information of the document attached according to the attribute information table 34B is sent from the document information management server 3 to the printer management server 4 for determining the limiting contents of the printing function. However, in the following example, as the printer management server 4 receives the user information of the user information table 35B together with the attribute information of the document from the document information management server 3, it is possible to execute an even finer control by the printer management server 4.

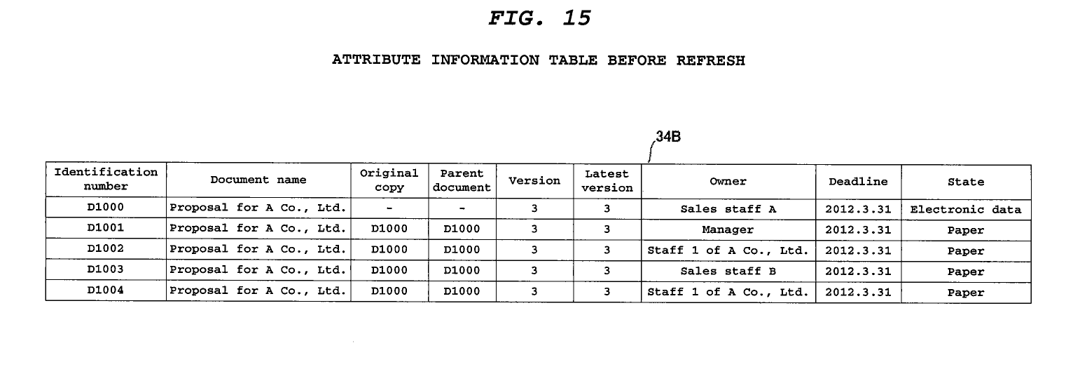

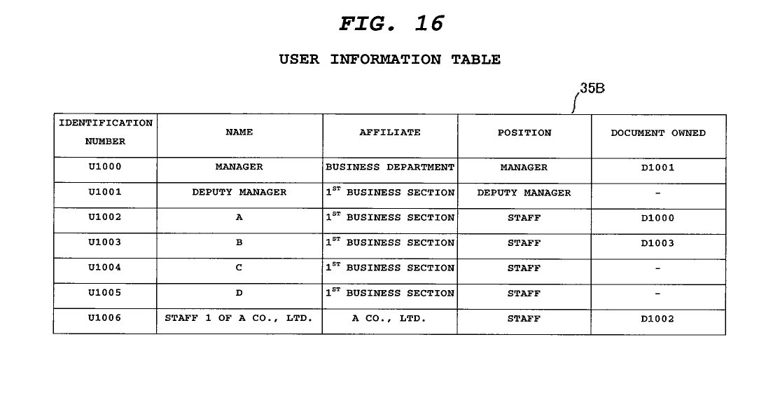

FIG. 15 is a diagram illustrating an attribute information table 34B after refresh. FIG. 16 is a diagram illustrating the user information table 35B.

Suppose the sales staff B prints the document D1003 for distributing to staff 1 of A Co., Ltd. In this case, the document identification number of “D1003”, the distribution destination of “staff 1 of A Co., Ltd.”, etc. are sent from the client PC via the printer management server 4 to the document information management server 3. As a result, the document information management server 3 attaches a new document identification number of “D1004” to the attribute information table 34B, and, at the same time, the various types of the attribute information (version, deadline, etc., the first attribute information) as well as the distribution destination of “staff 1 of A Co., Ltd.” (the second attribute information), etc. are made corresponding to the document identification number of “D1004”. Also, the document information management server 3 sends the information of the user information table 35B to the printer management server 4.

FIG. 17 is a diagram illustrating a printing policy table 45B.

According to this embodiment, the printing policy table 45B conditions the limiting contents of the printing function in the following manner: if the original copy of the document owned by the distribution destination and the original copy of the document to be distributed this time are identical to each other, the limiting contents of the printing function are set as monochromic/double-sided printing/N-in-1 printing. On the other hand, when the distribution destination is A Co., Ltd., color printing is permitted. FIG. 17 also shows the limiting contents of the printing function corresponding to the serial numbers of P003 through P005, respectively.

The printer management server 4 performs the limiting instruction of the printing function based on the document identification number of “D1003”, the distribution destination of “staff 1 of A Co., Ltd.”, the information of the attribute information table 34B, the information of the user information table 35B, and the information of the printing policy table 45B. More specifically, the printer management server 4 finds out from the user information table 35B that the distribution destination of “staff 1 of A Co., Ltd.” owns the document with the identification number of D1002 (the printer management server 4 acquires the identification number of D1002 corresponding to the distribution destination of “staff 1 of A Co., Ltd.”).

From the attribute information table 34B, the printer management server 4 determines that the original copy of D1000 of the document with the identification number of D1002 owned by the distribution destination of “staff 1 of A Co., Ltd.” is identical to the original copy of D1000 of the document with the identification number of D1003 with a request for printing.

As the condition described above is in agreement with the condition of the limiting instruction of the printing function made to correspond to the serial number of P001 of the printing policy table 45B, the printer management server 4 makes the printing instruction of the monochromic/double-sided printing/N-in-1 printing. In this case, the printer management server 4 may send the printing instruction in the PDL file sent from the client PC 2 to the image forming apparatus 1, and the client PC 2 may reflect the limiting instruction of the printing function in the printer driver screens 251, 252 and the print setting screen 236.

### Third Embodiment

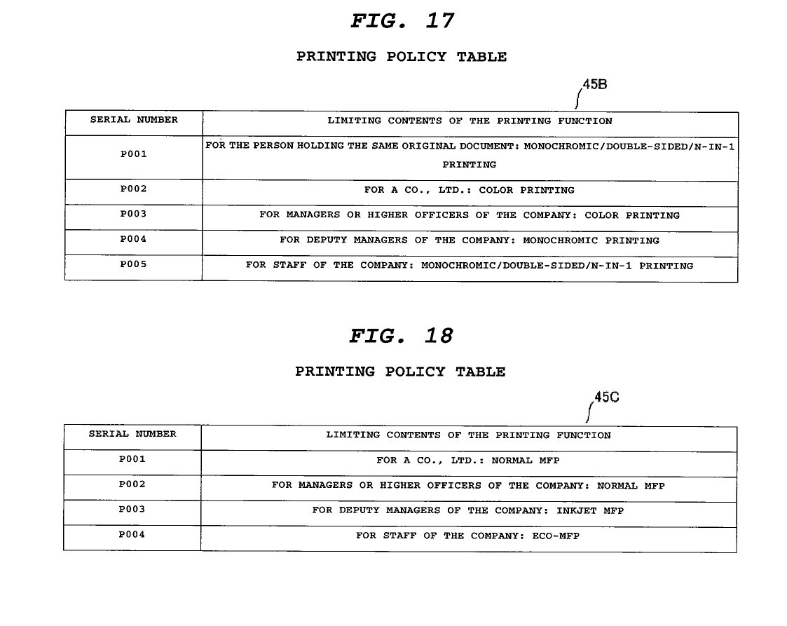

FIG. 18 is a diagram illustrating a printing policy table 45C.

According to a third embodiment, the limiting contents of the printing function correspond to which image forming apparatus 1 among the plural image forming apparatus 1 that can perform the printing operation.

In the printing policy table 45C, if the distribution destination is A Co., Ltd. as shown for serial number P001, normal MFP (with the identification number of A1000 in the printer information table 44 shown in FIG. 8) may be used for printing. When the distribution destination is the managers or higher officers in the company as shown for serial number P002, normal MFP (the identification number of A1000 as shown in FIG. 8) may be used for printing. When the distribution destination is the deputy managers of the company as shown for serial number P003, inkjet MFP (the identification number of A1002 shown in FIG. 8) may be used for printing. When the distribution destination is the regular staff of the company for serial number P004, Eco-MFP (the identification number of A1003 shown in FIG. 8) may be used for printing.

According to this embodiment, with the configuration described above, the emphasis is put on the image quality for the customers outside the company and the high officers within the company, and so use of the regular image forming apparatus 1 is permitted. For the level of deputy managers, the emphasis is put on the cost, and so use is limited to the inkjet image forming apparatus 1. For the staffers, the cost and the load on the environment are also considered, and so use is limited to image forming apparatus that print using an erasable toner.

In addition, instead of assigning types of image forming apparatus for performing the printing operation, it is also possible to prohibit printing by a certain image forming apparatus 1. When the client PC 2 receives, from the printer management server 4, a limiting instruction that prohibits printing by a certain image forming apparatus 1, the instruction contents may also be reflected on the printer driver screens 251, 252 (for example, the image forming apparatus 1 prohibited as the image forming apparatus 1 to print is set so as not to be available for selection).

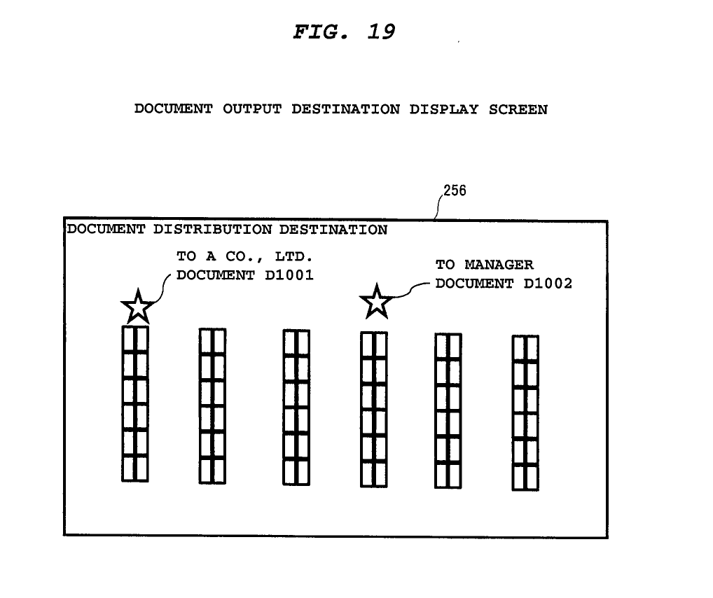

In addition, when the image forming apparatus 1 varies due to the distribution destination or other document attribute, it may be difficult for the user to specify the image forming apparatus 1 that outputs the target document. Here, when a PDL file is sent to a certain image forming apparatus 1 by the printer management server 4 itself as the limitation of the printing function, the printer management server 4 sends the information of the image forming apparatus 1 as the output destination of the document, the distribution destination, and the document identification number to the client PC 2 that has sent the request for printing. Here, the following scheme may be also be adopted: as shown in FIG. 19, based on these information types, the client PC 2 displays the document output destination display screen 256 that displays what is the destination (certain distribution destination) of the document and which image forming apparatus 1 on the floor printed the document.

### Fourth Embodiment

In the third embodiment, explanation has been made on the example in which the image forming apparatus 1 of the output destination is instructed for each document. However, when the printing instruction is sent to plural image forming apparatus 1 at the same time, and all of them output simultaneously, a difference in time takes place in recovery of the document, which is undesirable from the viewpoint of security. Also, when there are plural image forming apparatus 1 that can output, instead of the image forming apparatus 1 determined beforehand, the user may want to select the image forming apparatus 1 that is in an idle state at the time of printing.

More specifically, after the printer management server 4 describes the limiting instruction of the printing function as explained above (such as the instruction of monochromic/double-sided printing/N-in-1 printing) in the PDL file, instead of sending the PDL file to the image forming apparatus 1, the PDL file is stored in the printer management server 4.

Then, the image forming apparatus 1 carries out user authentication, and waits for the user to login.

The printer management server 4 stores the user identification number (identification information) showing the document owner or the distribution destination, and sends the document identification number of the attribute information and the attribute information (document name, version, etc.) to the image forming apparatus 1 that has carried out user login authentication.

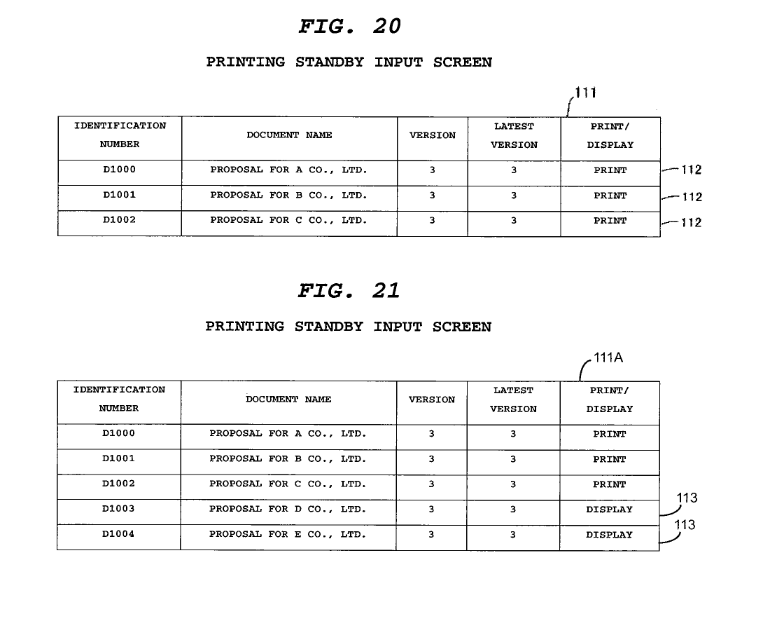

FIG. 20 is a diagram illustrating a printing standby input screen 111.

As shown in FIG. 20, the image forming apparatus 1 displays the printing standby input screen 111 that displays a simple list of the documents that have been sent. On the printing standby input screen 111, the printing button 112 is set corresponding to the identification number and the attribute information of each document. As the user presses the printing button 112 on the right end corresponding to each document, the image forming apparatus 1 receives the printing instruction from the user, and sends the identification number of the document for which it has received the instruction, to the printer management server 4. The printer management server 4 then sends back the document PDL file corresponding to the received identification number to the image forming apparatus 1. The image forming apparatus 1 carries out printing based on the received PDL file.

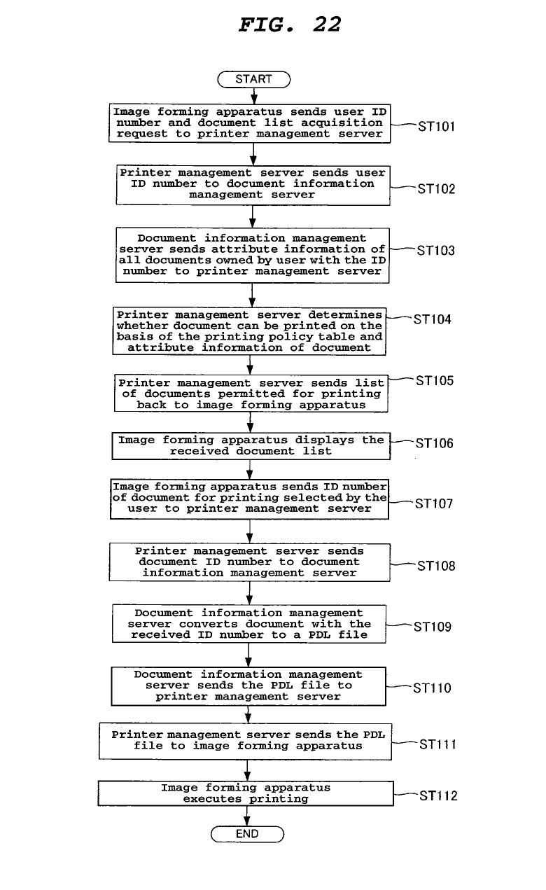

FIG. 21 is a diagram illustrating a printing standby input screen 111A.

Also, even when printing is not possible for the corresponding image forming apparatus 1 due to the limiting instruction of the printing function, it is still useful to indicate which image forming apparatus 1 can be used to print the document. Here, the printer management server 4 sends to the image forming apparatus 1 that has carried out the user login authentication the document identification number, the attribute information, and the limiting instruction of the printing function for each document (whether printing can be made with a certain image forming apparatus 1) stored in the printer management server 4 when printing is not yet carried out with a certain image forming apparatus although there is a request for printing.

As shown in FIG. 21, for the document that is stored in the printer management server 4 while not yet printed by a certain image forming apparatus although there is a request for printing, the image forming apparatus 1 displays with the printing button 112 set corresponding to the identification number and the attribute information of the document. The image forming apparatus 1 is set corresponding to the display button 113 in the document that cannot be printed with the corresponding image forming apparatus 1 under the limiting instruction of the printing function. After receiving the input by pressing the display button 113, the image forming apparatus 1 displays on the screen 256 shown in FIG. 19 whether the document can be printed by a certain image forming apparatus 1.

In the third embodiment, displayed on the document output destination display screen 256 shown in FIG. 19 is whether the document required for printing has been printed by certain image forming apparatus 1. However, according to this embodiment, it is shown whether the document set corresponding to the display button 113 can be printed by a certain image forming apparatus 1. In this embodiment, for the printed document, the image forming apparatus 1 sends the message of end of printing of the corresponding document to the printer management server 4.

### Fifth Embodiment

In the first to fourth embodiments, explanation has been made on the examples in which the client PC 2 receives a request for printing the document that has been read on the client PC 2. However, when the user already knows the contents of the document and there is no need to read the document again, in some cases, a more efficient configuration may be adopted in which a list of the documents that can be printed is displayed on the display section 11 of the image forming apparatus 1, and the request for printing is directly accepted. In the following, a brief account will be given on the present embodiment with reference to the flow of the document management process shown in FIG. 22.

First of all, the image forming apparatus 1 sends the user identification number (identification information) and the document list acquisition request to the printer management server 4 (ST101).

The printer management server 4 sends the user identification number to the document information management server 3 (ST102).

The document information management server 3 sends the attribute information of all of the documents owned by the user indicated by the identification number of the user to the printer management server 4 (ST103).

On the basis of the printing policy table 45 from the document attribute information, the printer management server 4 determines the limiting instruction of the printing function (which image forming apparatus 1 can print the document) (ST104).

The printer management server 4 sends the list of the documents allowed for printing by the image forming apparatus 1 back to the image forming apparatus 1 (ST105).

The image forming apparatus 1 displays the received document list (ST106).

The image forming apparatus 1 receives the introduction of printing of the document for printing selected by the user, and sends the identification number of the document to the printer management server 4 (ST107).

The printer management server 4 sends the document identification number to the document information management server 3 (ST108).

Here, according to the fifth embodiment, the document information management server 3 has the electronic data of each document set corresponding to the document identification number and stored beforehand.

The document information management server 3 uses the printer driver to convert the document of the received identification number to a PDL file (ST109).

The document information management server 3 sends the PDL file to the printer management server 4 (ST110).

The printer management server 4 sends the PDL file to the image forming apparatus 1 to be accessed (ST111).

The image forming apparatus 1 prints the document based on the PDL file (ST112).

With such configuration, for the document assigned from the list of the documents displayed, in addition to the rights of the user, the printing function is also controlled on the basis of the attribute information of the document, so that it is possible to suppress the printing cost and the load on the environment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document management system, comprising:
an image forming apparatus;
an acquisition section configured to receive an identification information of a document to be printed using the image forming apparatus;
a document information management server that maintains an attribute information table having identification information and attribute information of different documents stored therein, and retrieves the attribute information of the document having the identification information received by the acquisition section; and
a function limiting server that is configured to limit print functions of the image forming apparatus when printing the document having the identification information received by the acquisition section according to a printing policy that is based on the attribute information of the document retrieved by the document information management server.

2. The document management system according to claim 1, wherein
the acquisition section is configured to receive attribute information of the document; and
the printing policy is also based on the attribute information of the document received by the acquisition section.

3. The document management system according to claim 2, comprising:
a display control section configured to display a print setting screen reflecting the limited print functions of the image forming apparatus.

4. The document management system according to claim 2, wherein
the attribute information received by the acquisition section is a distribution destination of the document to be printed.

5. The document management system according to claim 1, wherein a print file is generated from the document to be printed and the limited print functions are described in the print file.

6. The document management system according to claim 1, wherein the function limiting server is further configured to limit types of image forming apparatus that can be used for printing.

7. The document management system according to claim 1, wherein the attribute information on which the printing policy is based includes a deadline for discarding the document to be printed.

8. The document management system according to claim 1, wherein the attribute information on which the printing policy is based includes a version of the document to be printed.

9. The document management system according to claim 1, wherein the function limiting server is configured to limit printing of the document to certain types of image forming apparatus based on distribution destination of the document to be printed.

10. The document management system according to claim 9, wherein the types of image forming apparatus include an image forming apparatus that employs erasable ink.

11. A function limiting server of a document management system having an image forming apparatus, comprising:
a printing policy table that has a plurality of entries, each of which associates attribute information of documents to be printed and one or more print functions of the image forming apparatus; and
a control section that is configured to cause the print functions of the image forming apparatus that are associated with attribute information of a document to be printed, to become limited.

12. The function limiting server according to claim 11, wherein a print file is prepared for the document to be printed and the limited print functions of the image forming apparatus are described in the print file.

13. The function limiting server according to claim 11, wherein the function limiting server is further configured to limit types of image forming apparatus that can be used for printing, the types of image forming apparatus including an image forming apparatus that employs erasable ink.

14. A method of managing document printing, comprising:
receiving an identification information of a document to be printed using an image forming apparatus;
retrieving attribute information of the document having the received identification information from an attribute information table having identification information and attribute information of different documents stored therein; and
disabling print functions of the image forming apparatus when printing the document having the identification information according to a printing policy that is based on the retrieved attribute information of the document.

15. The method according to claim 14, further comprising:
receiving attribute information of the document in addition to the identification information,
wherein the printing policy is also based on the received attribute information.

16. The method according to claim 15, further comprising:
displaying a print setting screen reflecting the disabled print functions of the image forming apparatus.

17. The method according to claim 15, wherein
the received attribute information is a distribution destination of the document to be printed.

18. The method according to claim 14, further comprising:
generating a print file is from the document to be printed; and
modifying the print file to describe the disable print functions therein.

19. The method according to claim 14, wherein the attribute information on which the printing policy is based includes a deadline for discarding the document to be printed.

20. The method according to claim 14, wherein the attribute information on which the printing policy is based includes a version of the document to be printed.
